(19) United States
(12) Patent Application Publication
(10) Pub. No.: US 2018/0087755 A1
(43) Pub. Date: Mar. 29, 2018

(54) ADJUSTABLE LED GROW LIGHT FIXTURES

(71) Applicant: Biological Innovation & Optimization Systems, LLC, Melbourne, FL (US)

(72) Inventors: Neil Yorio, Indian Harbour Beach, FL (US); Shane Sullivan, Indialantic, FL (US); Richard LeClair, Palm Bay, FL (US); Wei Sun, Indialantic, FL (US); Eric Thosteson, Satellite Beach, FL (US)

(73) Assignee: Biological Innovation & Optimization Systems, LLC, Cupertino, CA (US)

(21) Appl. No.: 15/709,933

(22) Filed: Sep. 20, 2017

Related U.S. Application Data
(60) Provisional application No. 62/401,378, filed on Sep. 29, 2016.

(51) Int. Cl. F21V 21/14; A01G 7/04; F21K 9/275

(52) U.S. Cl. CPC F21V 21/145; F21K 9/275; A01G 7/045

(57) ABSTRACT

Disclosed are adjustable LED grow light fixtures and lights that have low profiles and are configurable for different plant grow environments. Also disclosed are LED grow light fixtures that are fully assembled and collapsible to a compact configuration for efficient packaging and shipping. Embodiments include low profile and highly efficient LED lighting fixtures that are light, easily installed and are configurable to a variety of light distribution patterns.

### RELATED APPLICATIONS

This application claims priority to and the benefit of U.S. Provisional Application No. 62/401,378, filed Sep. 29, 2016, the contents of which are incorporated herein in their entirety.

Except to the extent that any of the disclosure in the referenced patents conflicts with the disclosure herein, the following US patents and published applications, which include inter alia disclosure pertaining to light emitting diode (LED) luminaires, fixtures, and light engines and LED grow lights, are incorporated herein by reference in their entireties: U.S. Pat. Nos. 8,749,163, 8,668,350, and 8,749,160; US published applications: 20170135176, 20100020536, 20130139437, 20120104977, 20160360712 and 20170023193.

### FIELD OF THE INVENTION

Embodiments of the invention generally relate to adjustable LED grow light fixtures and lights and low profile grow lighting fixtures wherein the lighting fixtures may be adjusted in various configurations to facilitate plant growth under various conditions and lighting fixtures that may be easily configured for efficient packaging and shipping.

### BACKGROUND OF THE INVENTION

Indoor agricultural and horticultural operations where plants are grown under artificial lighting are increasingly commonplace. Some advantages of indoor plant growth operations include allowing for extended growing cycles, increased yield per unit area (e.g., vertical framing), fine tuning of environmental variables including light output to enhance plant yield, security and enhanced ability to monitor the operation. Various types of grow lights are available including incandescent, fluorescent, compact fluorescent, metal halide, high pressure sodium, and light emitting diode (LED) based lighting. Each type presents unique characteristics, such as, cost to purchase, cost to operate, efficiency, light spectrum and radiant power output, etc. Important features of plant grow lights include providing the appropriate amount of photosynthetically active radiation (PAR) to ensure and optimize plant growth. Providing the appropriate radiant spectrum and power while minimizing energy consumption is another important goal of indoor growing operations and a benchmark metric of plant growth fixtures.

Light emitting diode (LED) technology is rapidly being applied to the agricultural and horticultural fields to allow for high efficiency indoor plant cultivation and growth. The increased energy efficiency of LED technology compared with other lighting solutions coupled with the reduction of costs of the LED themselves are increasing the number of LED applications and rates of adoptions across industries. Examples of such industries and markets include plant growing applications spanning the breadth from small indoor home greenhouses and nurseries to full scale indoor farming facilities. LEDs and associated technologies are becoming increasingly electrically efficient and are supplanting other lighting technologies because of this efficiency and associated cost savings. LED technology can also deliver greater reliability and lighting fixture longevity compared with other lighting technologies.

Importantly, LED technology and solid state lighting (SSL) in general provide platforms to allow the tailoring and customization of light output spectra to meet the demands of any specific application thereby increasing efficiency and optimizing the light output to meet the desired application. This feature of tailoring and tuning output spectra of LED fixtures can be used in grow lighting and other arenas to provide the specific wavelengths and wavelength ranges tailored and optimized to the specific application. For example, LED lights with specific wavelengths in the far red and ultraviolet bands are of interest to some growers for use during certain stages of plant growth. Illumination of plants with these specific wavelength regions can provoke or elicit specific and positive plant development and growth responses. Other examples of tailoring light incident on plants include adjusting the intensity of radiation emitted from the grow light fixture, adjusting the fixture's distance from the plant or plant canopy, and adjusting the orientation of the fixture or portions thereof relative to plant or plants. Generally, the tailoring of the output light spectrum, and the distance from and/or orientation of the light fixtures to the plants to optimize the amount photo-synthetically radiation incident on plant targets, depending on the plant species and/or growth cycle, can both reduce energy consumption and enhance plant growth and yield.

Embodiments of the invention include an adjustable LED grow light fixture comprising a first section containing a first light bar, a second section containing a second light bar, a third section to which each of said first and second sections are independently attached, means for connecting each of said first section and said second section to said third section such that each of said first and second sections may be independently rotated relative to said third section, and means for securing each of said first and second sections to said third section in one of a plurality of different fixture configurations. In some embodiments, the grow light fixture may be configured in a planar configuration wherein said first, second and third sections are generally oriented in a coplanar or near coplanar configuration and wherein said first and second sections are not rotated relative to said third section. In some embodiments, the grow light fixture may also be configured in a packaging or shipping configuration wherein said first and second sections are each rotated at an angle in excess of 70 degrees relative to said third section. In some embodiments, the grow light fixture is configured such that the first and second sections are each rotated at an angle of about 90 degrees relative to said third section for easy packing and shipping. In some embodiments, the grow light fixture may be in a plurality of configurations including an operational configuration wherein the fixture generates illumination and another of said configurations is a storing, packaging or shipping configuration different from said operational configuration.

Embodiments of the invention also include an adjustable LED grow light fixture comprising a first section containing a first light bar, a second section containing a second light bar, a third section to which each of said first and second sections are independently attached, means for connecting each of said first section and said second section to said third section such that each of said first and second sections may be independently rotated relative to said third section, and means for securing each of said first and second sections to said third section in one of a plurality of different fixture configurations and wherein the light fixture remains an integral unit while in the storing, packaging or shipping configuration and wherein the first and second sections are attached and secured to the third section. In some embodiments, configurations of the LED grow light fixture include a lateral light distribution configuration wherein said first and second sections are rotated such that portions of the said first or second sections extend above the plane of said third section and such that illumination generated from the light bars of each of said first and second sections is directed to a greater lateral extent, outward of said light fixture, than illumination generated by the light bars in a planar configuration. In other embodiments, configurations of the LED grow light fixture include a medial light distribution configuration wherein said first and second sections are rotated such that portions of said sections extend below the plane of said third section and such that illumination generated from the light bars of each of said first and second sections is directed to a greater medial extent, inward of said light fixture, than illumination generated in a planar configuration.

In some embodiments the connecting means for connecting each of first and second sections to the third sections comprises a hinge or hinge mechanism. In some embodiments the securing means for securing each of first and second sections to the third sections comprises a pin.

In some embodiments of the LED grow light fixture, the ratio of width of the light fixture to the length of the light fixture when the fixture is in the planar configuration is less than about 0.1. In some embodiments of the LED grow light fixture, the ratio of width of the light fixture to the length of the light fixture when the fixture is in the shipping configuration is greater than about 0.4.

Embodiments of the invention include an adjustable LED grow light fixture comprising a first section comprising a first light bar, a second section comprising a second light bar, a third section comprising a power supply, and means for connecting said first section and said second section to said third section wherein said first and second sections may each be independently inclined or declined relative to one or more central axes of the light fixture and means for securing wherein each of said first and second sections may be independently secured in a plurality of inclined or declined configurations with respect to said third section. In some embodiments, said first section and said second section each comprise multiple light bars.

In some embodiments of the LED grow light fixture, the third section includes a first power supply and a second power supply wherein the first power supply supplies power to energize the light bars of said the first section and the second power supply supplies power to energize the light bars of said second section. In some alternative embodiments, the means for connecting comprises one or more hinges and said means for securing comprises one or more pins. In some embodiments, the illumination spectrum generated by the light bars of the LED fixture is optimized for plant growth.

Additional embodiments include an adjustable LED grow light fixture that can be configured in an operational configuration and in a different shipping configuration while remaining an integral unit comprising a first section comprising a first light bar, a second section comprising a second light bar, and a third section comprising a power supply and to which each of said first and second sections are independently connected wherein said first and second sections are each connected to said third section by a first and second hinge respectively whereby said first and second sections may be independently rotated relative to said third section to form an operational configuration and a different shipping configuration wherein the ratio of the width of the fixture to the length of the fixture in the operational configuration is less than about 0.1 and the ratio of the width of the fixture to the length of the fixture in the shipping configuration is greater than about 0.4. Embodiments of the adjustable LED grow light fixture include means of securing said first and second sections to said third in a plurality of fixed configurations. In some embodiments, the plurality of configurations include a planar configuration, an incline configuration and a declined configuration.

### BRIEF DESCRIPTION OF THE DRAWINGS

FIG. 1 shows a perspective view of an adjustable LED light fixture according to some embodiments.

FIGS. 2a-d shows 2-dimensional views of a mechanically adjustable LED light fixture according to some embodiments.

FIG. 3 illustrates an exploded view of an adjustable LED light Fixture according to some embodiments.

FIG. 4 show an adjustable LED light fixture in a shipping configuration according to some embodiments.

FIG. 5 show an adjustable LED light fixture in a planar configuration according to some embodiments.

FIG. 6 show an adjustable LED light fixture in an inclined configuration according to some embodiments.

FIG. 7 show an adjustable LED light fixture in a declined configuration i according to some embodiments.

### DETAILED DESCRIPTION

Although the following detailed description contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention.

With reference to the figures and according to some embodiments, an adjustable LED fixture 100 comprises integrated light modules or bars 150, each comprising one or more LEDs (not shown), for providing light output; one or more power supplies 20 for powering and driving the light bars 150. The fixture 100 also comprises means for receiving electrical power such as an AC power cord (not shown). Additionally, the mechanically adjustable fixture comprises adjustable arm sections, 110 and 120 that are connected to a central body portion third section 130 via hinges or hinged means 160 that allow for the rotation of the arm sections about the central body third section portion 130. The arms 110 and 120 are attached to the central body portion 130 via an adjustable or hinged attachments means 160 that allow the arm sections 110 and 120 to rotate relative to the central body section 130. According to some embodiments, cotter pins 170 are used to secure arm sections 110 and 120 into one or more specific position or configuration with respect to the central body section 130. In some embodiments, holes in each of an arm sections, 110 and 120, and the central body section 130 are aligned in one or more specific configurations and a cotter pin 70 is inserted to retain the arm sections 110 and 120 in a fixed position relative to the central body section 120. A variety of specific forms of attachment and mechanisms allowing for hinged operation between the arm sections 110 and 120 and central body section 130 and for securing said sections are possible as will be evident to those skilled in the art.

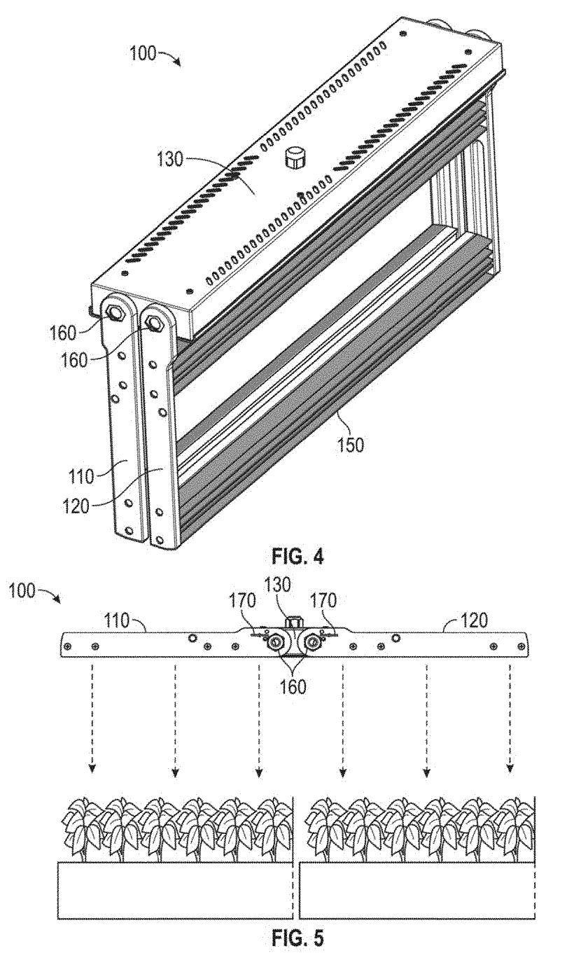

In some embodiments, the hinged attachment of the arm sections 110 and 120 to the central body section 130 allow the fixture 100 to be folded or otherwise adjusted to reduce the fixture's linear extent, making it more compact. An example of this is shown in FIG. 4. The ability to fold or otherwise make fixtures 100 more compact or “collapsible”, allows for greater efficiency in packing, handling and shipping and provides cost savings. For example, in the foldable state, a greater number of fixtures per shipping/packing carton can be achieved. Also, packing and shipping in the foldable state may provide greater security and insulate the fixtures from damage, and reduce the cost of packing materials or containers.

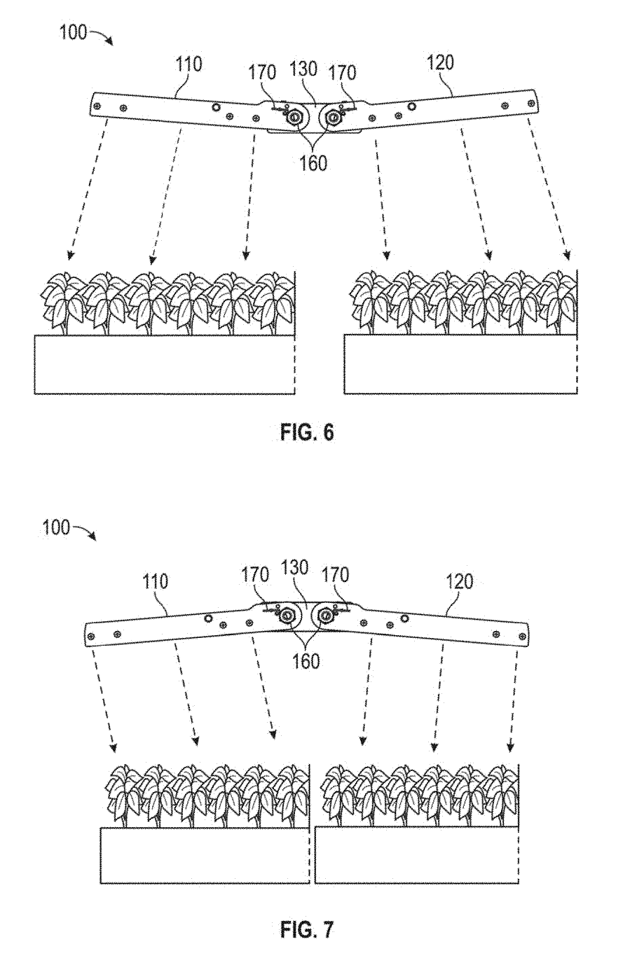

In some embodiments, the hinged arm sections 110 and 120 may be rotated above or below the central body section 130 and secured in specific relative configurations, e.g., using a cotter pin 170. Such adjustable configurations are beneficial in plant growing operations where adjustments, including both coarse and fine, of light output and direction are important. FIGS. 5-7 illustrate these features of the invention according to some embodiments. FIG. 5 shows the arm section 110 and 120 and central body section 130 in a neutral position or planar position. FIG. 6 shows the arm sections, 110 and 120, and central body section 130 in an inclined position, wherein the arms sections are rotated relative to the central body section such that the ends of the arm sections are above the central body section. This configuration may be useful when a greater light distribution extending beyond the ends of the fixture, or other types of light distribution, is desired. FIG. 7 shows the arm section, 110 and 120, and the central body section 130 in a declined position, wherein the arms are rotated relative to the central body section such that the ends of the arm sections are below the central body section. This configuration may be useful when light distribution is not needed all the way to the linear extent of the fixture, and/or greater light concentration is wanted towards the central portion of the fixture, or for when other types of light distribution is desired.

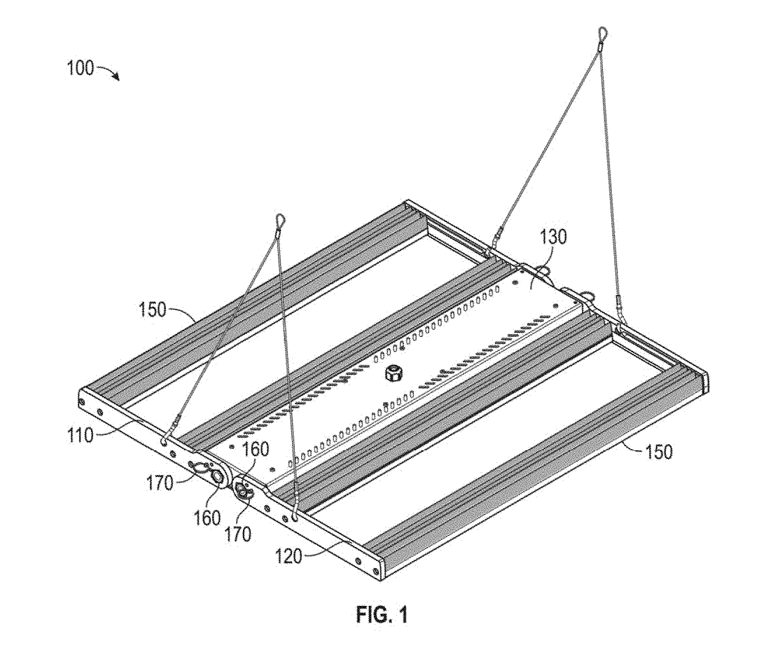

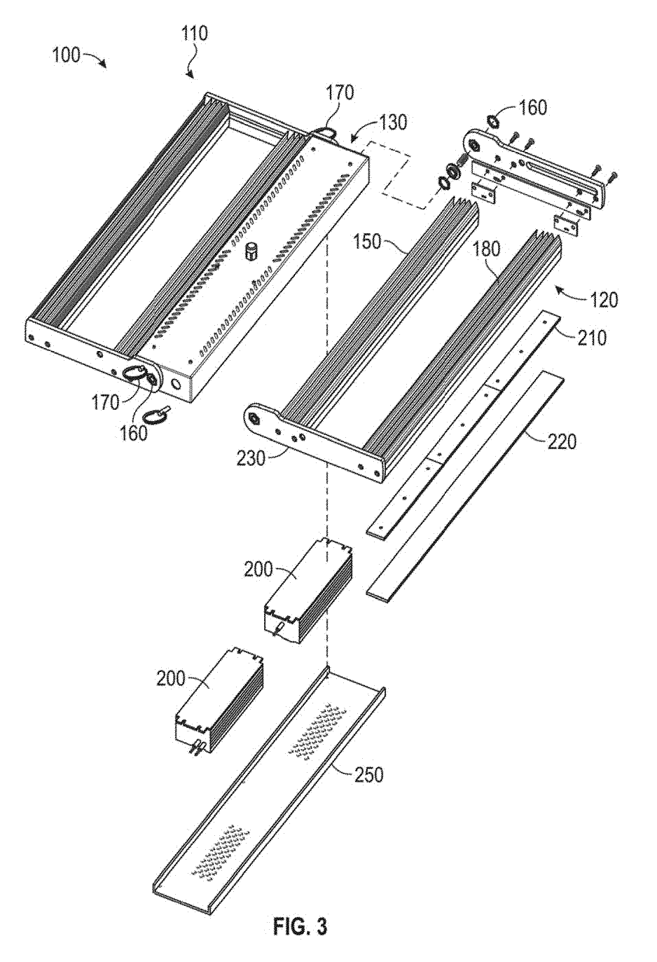

FIG. 1 shows an adjustable LED lighting fixture 100 according to some embodiments comprising a first section 110, a second section 120 and a third section 130, First and second sections, 110 and 120, comprise light bars 150, and the third section contains a power supply (not shown) for providing power to one or more of the light bars 150. The embodiment also includes an external electrical cable (not shown) for delivering external power to the power supply. The light bars each comprise a housing with heat sink, a light board with LEDs, and a covering optic as more fully shown in FIG. 3. The light board is connected to the power supply by a conductive wire (not shown). First section 110 and second section 120 are each connected to the third section 130 by a hinge 170 that permits first and second sections, 110 and 120, to independently rotate about the third section 130 to form different configuration of the adjustable lighting fixture 100. First section 110 and second section 120 are each independently secured to third section 130 in one of a plurality of configuration via pins 170. A first pin 170 secures first section to third section via insertion into mutually aligned holes of first section and third section. A second pin 170 secures second section to third section via insertion into mutually aligned holes of second section and third section. Although, the perspective view of FIG. 1 illustrates only one end of the fixture 100, first section 110 and second section 120 are connected and secured to the third section via hinges and pins respectively on both ends of the fixture 100.

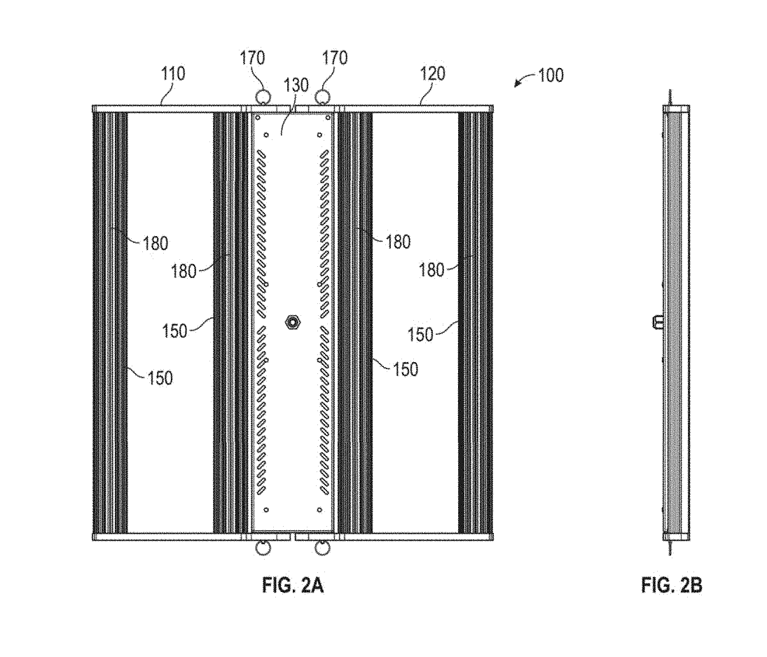

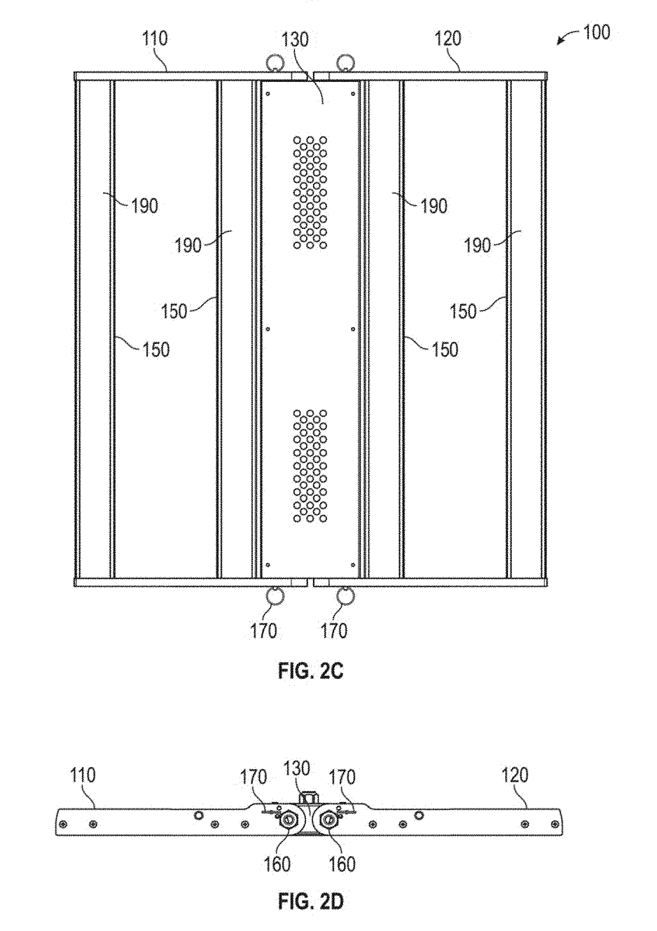

FIGS. 2a-d shows 2-dimensional views of a mechanically adjustable LED light fixture 100 according to some embodiments. FIG. 2a illustrates a top down view showing the first section 110, the second section 120 and the third section 130. Each of the first and second sections, 110 and 120, comprise light bars 150 with heat sinks 180. FIG. 2c shows a bottom view of the light fixture 100, with light bars 150 each comprising LED boards 190, and shows the securing pins 170. FIG. 2d is an end view of the fixture showing the first section 100, the second section 120, the third section 130, the hinged connecting means 160, independently connecting the first and second sections to the third section and the pins 170 securing the first and second sections to the third section.

FIG. 3 illustrates an exploded view of an adjustable LED light Fixture 100 according to some embodiments. First section 110 is connected and secured to the third section 130 via hinges 160 and pins 170 respectively. Second section 120 is shown in exploded view and, for illustrative purposes, disconnected from third section 130. Section 120 includes light bars 150. Each light bar 150 comprises an a housing with heat sink 180, an LED boards 210 containing LEDs and a covering optic 220. Section 120 also include structural support ends 230 which are used to inter alia connect section 120 to section 130. Section 120 is connected to section 130 via hinges 160 and secured in a specific orientation via pins 170. Also shown are two power supplies 200 which supply power to the light bars of the first and second sections. According to this embodiment, the power supplies are contained with an interior portion of the third section 130 being enclosed by cover 250 and are connected to the light modules via wires (not shown).

FIG. 4 show an adjustable LED light fixture in a shipping configuration according to some embodiments. Securing pins have been removed and are not shown. Sections 110 and 120 have been rotate about the third section 130 via independent hinges 160 to reduce the lateral extent of the fixture 100. This configuration facilitates efficient packaging, shipping and storage. As shown in this embodiment, sections 110 and 120 are each rotated approximately 90 degrees relative to the third section 130. Other angles of rotation are also possible.

FIG. 5 shows an adjustable LED light fixture in a planar configuration according to some embodiments. First section 110 and second section 120 are connected and secured in a planar configuration relative to the third section 130 via hinges 160 and pins 170 respectively. The pins secure the sections by inserting into mutually aligned holes of the respective sections. In this embodiment first and second sections, 110 and 120, are aligned generally with the plane of the third section 130 and are neither inclined or declined relative thereto.

FIG. 6 shows an adjustable LED light fixture in an inclined configuration according to some embodiments. First section 110 and second section 120 are connected and secured in an inclined configuration relative to the third section 130 via hinges 160 and pins 170 respectively. The pins secure the sections by inserting into mutually aligned holes of the respective sections. In this embodiment first and second sections, 110 and 120, extend above the plane of the third section 130 and distribute light to a greater lateral extent than in the planar configuration.

FIG. 7 shows an adjustable LED light fixture in a declined configuration according to some embodiments. First section 110 and second section 120 are connected and secured in a declined configuration relative to the third section 130 via hinges 160 and pins 170 respectively. The pins secure the sections by inserting into mutually aligned holes of the respective sections. In this embodiment first and second sections, 110 and 120, extend below the plane of the third section 130 and distribute light to a lesser lateral extent than in the planar configuration.

While the invention has been described with reference to exemplary embodiments, it will be understood by those skilled in the art that various changes may be made and equivalents may be substituted for elements thereof without departing from the scope of the invention. For example, embodiments of the invention are not limited to grow lights application or LED fixtures, but may be incorporated into any electrical systems which may benefit from limiting inrush current.

In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include many variants and embodiments. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. An adjustable LED grow light fixture comprising:
a first section comprising a first light bar;
a second section comprising a second light bar;
a third section to which each of said first and second sections are independently attached;
means for connecting each of said first section and said second section to said third section such that each of said first and second sections may be independently rotated relative to said third section; and
means for securing each of said first and second sections to said third section in one of a plurality of different fixture configurations.

2. The LED grow light fixture of claim 1 wherein one of said configurations comprises a planar configuration wherein said first, second and third sections are generally oriented in a coplanar or near coplanar configuration and wherein said first and second sections are not rotated relative to said third section.

3. The LED grow light fixture of claim 1 wherein one of said configurations comprises a packaging or shipping configuration wherein said first and second sections are each rotated at an angle in excess of 70 degrees relative to said third section.

4. The LED grow light fixture of claim 3 wherein said first and second sections are each rotated at an angle of about 90 degrees relative to said third section.

5. The LED grow light fixture of claim 1 wherein one of said plurality of configurations is an operational configuration wherein the fixture generates illumination and another of said configurations is a storing, packaging or shipping configuration different from said operational configuration.

6. The LED grow light fixture of claim 5 wherein the light fixture remains an integral unit while in the storing, packaging or shipping configuration and wherein the first and second sections are attached and secured to the third section.

7. The LED grow light fixture of claim 1 wherein one of said configurations comprises a lateral light distribution configuration wherein said first and second sections are rotated such that portions of the said first or second sections extend above the plane of said third section and such that illumination generated from the light bars of each of said first and second sections is directed to a greater lateral extent, outward of said light fixture, than illumination generated by the light bars in a planar configuration.

8. The LED grow light fixture of claim 1 wherein one of said configurations comprises a medial light distribution configuration wherein said first and second sections are rotated such that portions of said sections extend below the plane of said third section and such that illumination generated from the light bars of each of said first and second sections is directed to a greater medial extent, inward of said light fixture, than illumination generated in a planar configuration.

9. The LED grow light fixture of claim 1 wherein the connecting means for connecting each of first and second sections to the third sections comprises a hinge or hinge mechanism.

10. The LED grow light fixture of claim 1 wherein the securing means for securing each of first and second sections to the third sections comprises a pin.

11. The LED grow light fixture of claim 2 wherein the ratio of width of the light fixture to the length of the light fixture when the fixture is in the planar configuration is less than about 0.1.

12. The LED grow light fixture of claim 4 wherein the ratio of width of the light fixture to the length of the light fixture when the fixture is in the shipping configuration is greater than about 0.4.

13. An adjustable LED grow light fixture comprising:
a first section comprising a first light bar;
a second section comprising a second light bar;
a third section comprising a power supply; and
means for connecting said first section and said second section to said third section wherein said first and second sections may each be independently inclined or declined relative to one or more central axes of the light fixture and means for securing wherein each of said first and second sections may be independently secured in a plurality of inclined or declined configurations with respect to said third section.

14. The LED grow light fixture of claim 13 wherein said first section and said second section each comprise multiple light bars.

15. The LED grow light fixture of claim 14 wherein said third section includes a first power supply and a second power supply wherein the first power supply supplies power to energize the light bars of said the first section and the second power supply supplies power to energize the light bars of said second section.

16. The LED grow light fixture of claim 13 wherein said means for connecting comprises one or more hinges and said means for securing comprises one or more pins.

17. The LED grow light fixture of claim 13 wherein the illumination spectrum generated by said light bars is optimized for plant growth.

18. An adjustable LED grow light fixture that can be configured in an operational configuration and in a different shipping configuration while remaining an integral unit comprising:
a first section comprising a first light bar;
a second section comprising a second light bar; and
a third section comprising a power supply and to which each of said first and second sections are independently connected wherein said first and second sections are each connected to said third section by a first and second hinge respectively whereby said first and second sections may be independently rotated relative to said third section to form an operational configuration and a different shipping configuration wherein the ratio of the width of the fixture to the length of the fixture in the operational configuration is less than about 0.1 and the ratio of the width of the fixture to the length of the fixture in the shipping configuration is greater than about 0.4.

19. The adjustable LED grow light fixture of claim 18 further comprising means of securing said first and second sections to said third in a plurality of fixed configurations.

20. The adjustable LED grow light fixture of claim 19 wherein said plurality of configurations include a planar configuration, an incline configuration and a declined configuration.
